(19) United States
(12) Patent Application Publication
(10) Pub. No.: US 2014/0355471 A1
(43) Pub. Date: Dec. 4, 2014

(54) Method for Transmitting IDC Interference Information in Wireless Communication Systems and Apparatus for Same

(71) Applicant: LG Electronics Inc., Seoul (KR)

(72) Inventors: Jaewook Lee, Gyeonggi-do (KR); Sungjun Park, Gyeonggi-do (KR); Sunghoon Jung, Gyeonggi-do (KR); Youngdae Lee, Gyeonggi-do (KR); Seungjune Yi, Gyeonggi-do (KR)

(73) Assignee: LG ELECTRONICS INC., Seoul (KR)

(21) Appl. No.: 14/372,049

(22) PCT Filed: Jan. 18, 2013
(86) PCT No.: PCT/KR2013/000412

§ 371 Date: Jul. 14, 2014

Related U.S. Application Data
(60) Provisional application No. 61/595,700, filed on Feb. 7, 2012.
(60) Provisional application No. 61/602,597, filed on Feb. 24, 2012.

(51) Int. Cl. H04W 24/08

(52) U.S. Cl. CPC H04W 24/08
USPC 370/252

(57) ABSTRACT

The present invention relates to a method by which a first communication module of a terminal transmits IDC interference information to a base station in a wireless communication system, and to an apparatus for same. More particularly, the method includes the steps of receiving a first message instructing a specific event-related measurement setting from the base station; receiving a second message instructing the start of operations of second communication modules from one or more of the second communication modules coexisting in the terminal; measuring frequencies on the basis of information about the operating frequencies of the first and second communication modules; and transmitting the frequency measuring results to the base station when a specific event occurs.

### TECHNICAL FIELD

The present invention relates to a wireless communication system, and more particularly, to a method for transmitting IDC interference information in a wireless communication system and an apparatus for the same.

### BACKGROUND ART

A 3rd generation partnership project long term evolution (3GPP LTE) (hereinafter, referred to as ‘LTE’) communication system which is an example of a wireless communication system to which the present invention can be applied will be described in brief

FIG. 1 is a diagram illustrating a network structure of an Evolved Universal Mobile Telecommunications System (E-UMTS) which is an example of a wireless communication system. The E-UMTS is an evolved version of the conventional UMTS, and its basic standardization is in progress under the 3rd Generation Partnership Project (3GPP). The E-UMTS may be referred to as a Long Term Evolution (LTE) system.

For details of the technical specifications of the UMTS and E-UMTS, refer to Release 7 and Release 8 of “3rd Generation Partnership Project; Technical Specification Group Radio Access Network”.

Referring to FIG. 1, the E-UMTS includes a User Equipment (UE), base stations (eNode B; eNB), and an Access Gateway (AG) which is located at an end of a network (E-UTRAN) and connected to an external network. The base stations may simultaneously transmit multiple data streams for a broadcast service, a multicast service and/or a unicast service.

One or more cells exist for one base station. One cell is set to one of bandwidths of 1.25, 2.5, 5, 10, and 20 MHz to provide a downlink or uplink transport service to several user equipments. Different cells may be set to provide different bandwidths. Also, one base station controls data transmission and reception for a plurality of user equipments. The base station transmits downlink (DL) scheduling information of downlink data to the corresponding user equipment to notify the corresponding user equipment of time and frequency domains to which data will be transmitted and information related to encoding, data size, and hybrid automatic repeat and request (HARQ). Also, the base station transmits uplink (UL) scheduling information of uplink data to the corresponding user equipment to notify the corresponding user equipment of time and frequency domains that can be used by the corresponding user equipment, and information related to encoding, data size, and HARQ. An interface for transmitting user traffic or control traffic may be used between the base stations. A Core Network (CN) may include the AG and a network node or the like for user registration of the user equipment. The AG manages mobility of the user equipment on a Tracking Area (TA) basis, wherein one TA includes a plurality of cells.

Although the wireless communication technology developed based on WCDMA has been evolved into LTE, request and expectation of users and providers have continued to increase. Also, since another wireless access technology is being continuously developed, new evolution of the wireless communication technology will be required for competitiveness in the future. In this respect, reduction of cost per bit, increase of available service, use of adaptable frequency band, simple structure and open type interface, proper power consumption of the user equipment, etc. are required.

### DISCLOSURE

### Technical Problem

An object of the present invention devised to solve the conventional problem is to provide a method for transmitting IDC interference information in a wireless communication system and an apparatus for the same.

### Technical Solution

In one aspect of the present invention, a method for allowing a first communication module of a user equipment to transmit In-Device Coexistence (IDC) interference information to a base station in a wireless communication system comprises the steps of receiving a first message indicating measurement configuration associated with a specific event from the base station; receiving a second message indicating operation start of at least one second communication module coexisting in the user equipment from the at least one second communication module; measuring frequencies on the basis of operation frequency information of the first and second communication modules; and transmitting the frequency measured results to the base station when the specific event occurs.

In this case, the specific event is associated with handover of the user equipment, and the measured result of frequencies includes IDC interference information.

Moreover, the measured result of frequencies may further include frequency information affected by IDC interference or time division multiplexing (TDM) information.

Preferably, the measured result of frequencies further includes an identifier on a specific frequency band if the specific event is configured for the specific frequency band. Also, the measured result of frequencies further includes IDC interference information on a frequency band except for the specific frequency among frequency bands configured by the base station.

Preferably, operation start of the second communication module is a power-on operation of the second communication module or a traffic transmission and reception operation of the second communication module. The at least one second communication module includes at least one of a transceiving module for a WiFi system, a Bluetooth transceiving module, and a global positioning system (GPS) receiving module.

Moreover, the first message is a configuration (reportConfig) message for measurement reporting, and is configured to further include a bit indicating IDC interference information reporting.

In another aspect of the present invention, a user equipment in a wireless communication system comprises a first communication module for transmitting and receiving a signal to and from a first communication system; and at least one second communication module for transmitting and receiving a signal to and from another communication system, wherein the first communication module receives a first message indicating measurement configuration associated with a specific event from the base station, receives a second message indicating operation start of the at least one second communication module coexisting in the user equipment from the at least one second communication module, measures frequencies on the basis of operation frequency information of the first and second communication modules, and transmits the frequency measured results to the base station when the specific event occurs.

### Advantageous Effects

According to the aforementioned embodiments of the present invention, the user equipment may effectively transmit IDC interference information.

It will be appreciated by persons skilled in the art that that the effects that could be achieved with the present invention are not limited to what has been particularly described hereinabove and other advantages of the present invention will be more clearly understood from the following detailed description.

### BRIEF DESCRIPTION OF THE DRAWINGS

FIG. 1 is a diagram briefly illustrating a network structure of an Evolved Universal Mobile Telecommunications System (E-UMTS), which is an example of a wireless communication system;

FIG. 2 is a diagram conceptionally illustrating a network structure of an evolved universal terrestrial radio access network (E-UTRAN);

FIG. 3 is a diagram illustrating structures of a control plane and a user plane of a radio interface protocol between a user equipment and an E-UTRAN based on the 3GPP radio access network standard;

FIG. 4 is a diagram illustrating a user equipment that includes wireless communication modules for an LTE system, a global positioning system (GPS), and a BT/WiFi system;

FIG. 5 is a flow chart illustrating a method for allowing a user equipment to transmit IDC interference information in accordance with the embodiment of the present invention;

FIGS. 6 and 7 are reference diagrams illustrating a method for allowing a user equipment to transmit IDC interference information in accordance with the first embodiment of the present invention;

FIG. 8 is a reference diagram illustrating a method for allowing a user equipment to transmit IDC interference information in accordance with the second embodiment of the present invention; and

FIG. 9 is a block diagram illustrating a transceiver according to the embodiment of the present invention.

### BEST MODE FOR CARRYING OUT THE INVENTION

Hereinafter, configurations, operations, and other features of the present invention will be understood readily by the preferred embodiments of the present invention, examples of which are illustrated in the accompanying drawings. Embodiments described later are examples in which technical features of the present invention are applied to 3GPP system.

Although the embodiment of the present invention will be described based on the LTE system and the LTE-A system in this specification, the LTE system and the LTE-A system are only exemplary, and the embodiment of the present invention may be applied to all communication systems corresponding to the aforementioned definition. Also, although the embodiment of the present invention will be described based on an FDD mode in this specification, the FDD mode is only exemplary, and the embodiment of the present invention may easily be applied to an H-FDD mode or a TDD mode.

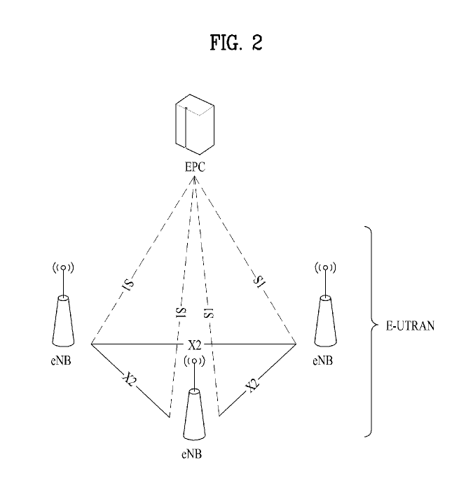

FIG. 2 is a diagram conceptionally illustrating a network structure of an Evolved Universal Terrestrial Radio Access Network (E-UTRAN) which is an example of a mobile communication system. In particular, the E-UTRAN system is an evolved version of the conventional UTRAN system. The E-UTRAN includes cells (eNBs), which are connected with each other through an interface X2. Also, each of the cells is connected with a user equipment (UE) through a radio interface and connected with an evolved packet core (EPC) through an interface S1.

The EPC includes a mobility management entity (MME), a serving-gateway (S-GW), and a packet data network-gateway (PDN-GW). The MME includes access information of the user equipment or ability information of the user equipment. The access information or the ability information is mainly used for mobility management of the user equipment. The S-GW is a gateway having the E-UTRAN as an end point, and the PDN-GW is a gateway having a packet data network (PDN) as an end point.

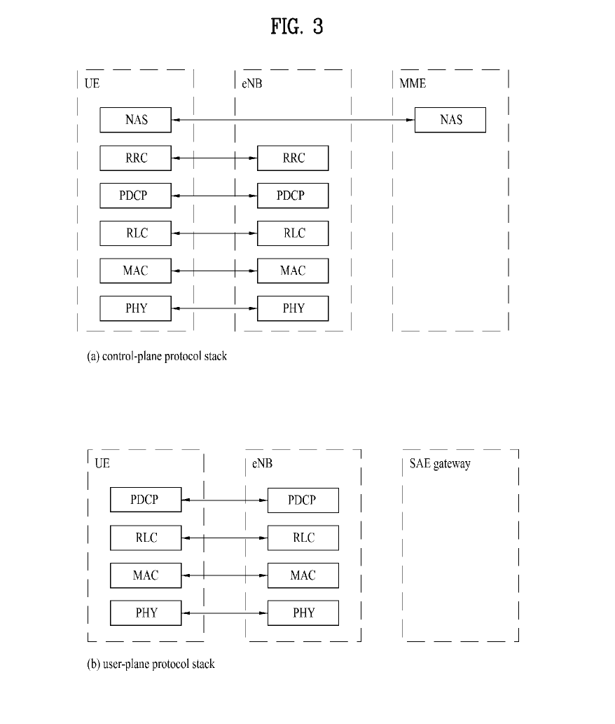

FIG. 3 is a diagram illustrating structures of a control plane and a user plane of a radio interface protocol between a user equipment and E-UTRAN based on the 3GPP radio access network standard. The control plane means a passageway where control messages are transmitted, wherein the control messages are used by the user equipment and the network to manage call. The user plane means a passageway where data generated in an application layer, for example, voice data or Internet packet data are transmitted.

A physical layer as the first layer provides an information transfer service to an upper layer using a physical channel. The physical layer is connected to a medium access control (MAC) layer via a transport channel, wherein the medium access control layer is located above the physical layer. Data are transferred between the medium access control layer and the physical layer via the transport channel. Data are transferred between one physical layer of a transmitting side and the other physical layer of a receiving side via the physical channel. The physical channel uses time and frequency as radio resources. In more detail, the physical channel is modulated in accordance with an orthogonal frequency division multiple access (OFDMA) scheme in a downlink, and is modulated in accordance with a single carrier frequency division multiple access (SC-FDMA) scheme in an uplink.

A medium access control (MAC) layer of the second layer provides a service to a radio link control (RLC) layer above the MAC layer via a logical channel. The RLC layer of the second layer supports reliable data transmission. The RLC layer may be implemented as a functional block inside the MAC layer. In order to effectively transmit data using IP packets such as IPv4 or IPv6 within a radio interface having a narrow bandwidth, a packet data convergence protocol (PDCP) layer of the second layer performs header compression to reduce the size of unnecessary control information.

A radio resource control (RRC) layer located on the lowest part of the third layer is defined in the control plane only. The RRC layer is associated with configuration, re-configuration and release of radio bearers (‘RBs’) to be in charge of controlling the logical, transport and physical channels. In this case, the RB means a service provided by the second layer for the data transfer between the user equipment and the network. To this end, the RRC layers of the user equipment and the network exchange RRC message with each other.

One cell constituting a base station eNB is set to one of bandwidths of 1.25, 2.5, 5, 10, 15, and 20 MHz and provides a downlink or uplink transmission service to several user equipments. At this time, different cells may be set to provide different bandwidths.

As downlink transport channels carrying data from the network to the user equipment, there are provided a broadcast channel (BCH) carrying system information, a paging channel (PCH) carrying paging message, and a downlink shared channel (SCH) carrying user traffic or control messages. Traffic or control messages of a downlink multicast or broadcast service may be transmitted via the downlink SCH or an additional downlink multicast channel (MCH).

Meanwhile, as uplink transport channels carrying data from the user equipment to the network, there are provided a random access channel (RACH) carrying an initial control message and an uplink shared channel (UL-SCH) carrying user traffic or control message. As logical channels located above the transport channels and mapped with the transport channels, there are provided a broadcast control channel (BCCH), a paging control channel (PCCH), a common control channel (CCCH), a multicast control channel (MCCH), and a multicast traffic channel (MTCH).

Hereinafter, RRC state of the user equipment and RRC connection method will be described. The RRC state means whether the RRC layer of the user equipment is logically connected with the RRC layer of the E-UTRAN. If the RRC layer of the user equipment is logically connected with the RRC layer of the E-UTRAN, it may be referred to as RRC connected (RRC_CONNECTED) state. If not so, it may be referred to as RRC idle (RRC_IDLE) state.

Since the E-UTRAN may identify the presence of the user equipment which is in the RRC_CONNECTED state, on the basis of cell unit, the E-UTRAN may effectively control the user equipment. On the other hand, the E-UTRAN may not identify the user equipment which is in the RRC_IDLE state, on the basis of cell unit. In this case, the user equipment is managed by the core network (CN) on the basis of tracking area (TA) unit which is a local unit greater than the cell unit. In other words, in order that the user equipment which is in the RRC_IDLE state receives a normal mobile communication service such as voice or data, the user equipment should be shifted to the RRC_CONNECTED state.

In particular, when the user initially turns on the power of the user equipment, the user equipment searches for a proper cell and then is maintained in the RRC_IDLE state in the corresponding cell. The user equipment maintained in the RRC idle state performs RRC connection establishment procedure with the RRC layer of the E-UTRAN only if the RRC connection is required, and then is shifted to the RRC_CONNECTED state. In this case, the case where the RRC connection is required may include a case where uplink data transmission is required due to calling attempt of the user or a case where a response message to a paging message received from the E-UTRAN should be transmitted.

Hereinafter, measurement and measurement reporting will be described.

In the following description, ‘measurement’ may be defined that the user equipment measures a quality value of a corresponding cell by receiving reference signals received from cells located in inter-frequency, intra-frequency and inter-RAT in accordance with measurement configuration received from the network. Also, ‘quality’ means signal quality or cell quality identified by the reference signal received from a target cell for measurement.

In respect of mobility support of the user equipment in the mobile communication system, the user equipment continues to measure quality of a serving cell, which currently provides a service, and quality of a neighboring cell per at least discontinuous reception (DRX) period. The user equipment reports the measured result of cell quality to the network at a proper time, and the network provides optimized mobility to the user equipment through handover, etc.

The user equipment may perform measurement of a specific purpose set by the network to provide information, which may assist a network provider to manage the network, in addition to the purpose of mobility support, and may report the measured result of cell quality to the network. For example, the user equipment receives broadcast information of a specific cell determined by the network. The user equipment may report cell identify (referred to as global cell identity) of the specific cell, location identification information (for example, tracking area code) to which the specific cell belongs, and/or other cell information (for example, whether the cell is a member of a closed subscriber group (CSG) cell or not) to the serving cell.

In the 3GPP LTE, the base station may configure one measurement target only for one frequency band for the user equipment. According to section 5.5.4 of 3GPP TS 36.331 V10.6.0(2012-06) “Evolved Universal Terrestrial Radio Access(E-UTRA) Radio Resource Control(RRC); Protocol specification (Release 8)”, events for triggering measurement reporting as illustrated in the following Table 1 are defined.

TABLE 1

| Event | Report conditions |
|---|---|
| Event A1 | Serving becomes better than threshold |
| Event A2 | Serving becomes worse than threshold |
| Event A3 | Neighbor becomes offset better than serving |
| Event A4 | Neighbor becomes better than threshold |
| Event A5 | Serving becomes worse than threshold1 and neighbor becomes |
| | better than threshold2 |
| Event B1 | Inter RAT neighbor becomes better than threshold |
| Event B2 | Serving becomes worse than threshold1 and inter RAT |
| | becomes better than threshold2 |

If the measured result of the user equipment satisfies the configured event, the user equipment transmits a measurement report message to the base station.

If the user equipment which is moving identifies that quality of a specific zone is very bad, through measurement, the user equipment may report location information of the cells of which quality is bad and the measured result of cell quality to the network. The network may optimize the network on the basis of the report of the measured result of cell quality of the user equipments that assist management of the network.

In a mobile communication system of which frequency reuse factor is 1, most of mobility is made between different cells of the same frequency band. Accordingly, in order to ensure mobility of the user equipment, the user equipment should measure quality of neighboring cells having the same center frequency as that of the serving cell and cell information well. In this way, measurement of the cell having the same center frequency as that of the serving cell will be referred to as intra-frequency measurement. The user equipment performs intra-frequency measurement and timely reports the result of measurement of cell quality to the network, whereby the purpose of the measured result of corresponding cell quality may be obtained.

A mobile communication provider may manage the network by using a plurality of frequency bands. If a service of the communication system is provided through the plurality of frequency bands, in order to ensure optimized mobility of the user equipment, the user equipment should measure quality of neighboring cells having center frequency different from that of the serving cell and cell information well. In this way, measurement of the cell having center frequency different from that of the serving cell will be referred to as inter-frequency measurement. The user equipment should perform inter-frequency measurement and timely report the result of measurement of cell quality to the network.

If the user equipment supports measurement of heterogeneous networks, cell measurement of the heterogeneous networks may be performed by setup of the base station. This measurement of the heterogeneous networks will be referred to as inter-radio access technology (inter-RAT) measurement. For example, RAT may include a UMTS Terrestrial Radio Access Network (UTRAN) and a GSM EDGE Radio Access Network (GERAN) according to the 3GPP standard specifications, and may also include CDMA 2000 system according to the 3GPP2 standard specifications.

Hereinafter, In-Device Coexistence (IDC) and IDC interference will be described.

In order that the user accesses various networks anytime anywhere, it is required that one user equipment should be provided with a transceiver for a wireless communication system such as LTE, WiFi, and Bluetooth (BT) and a global navigation satellite system (GNSS) receiver. Coexistence of different wireless communication systems in one user equipment will be referred to as IDC (In-Device Coexistence). Such examples may include a user equipment provided with LTE and BT modules for VoIP service and multimedia service through a BT earphone, a user equipment provided with LTE and WiFi modules for traffic distribution, and a user equipment provided with GNSS and LTE modules for additionally acquiring location information.

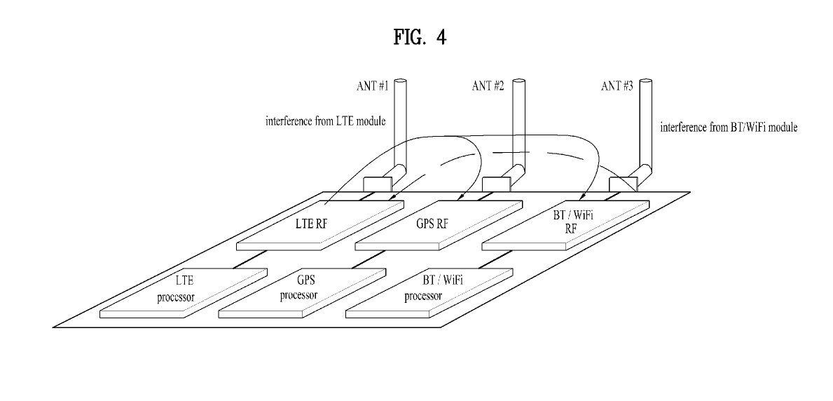

FIG. 4 is a diagram illustrating a user equipment that includes wireless communication modules for an LTE system, a global positioning system (GPS) and a BT/WiFI system.

Referring to FIG. 4, as several transceivers are located near one another within one user equipment, the power of a signal transmitted from one transceiver may be greater than that of a signal transmitted from another transceiver. In this case, interference may occur between different communication modules. This interference will be referred to as IDC interference. If IDC interference becomes serious, even though there is no problem in connection between the user equipment and the base station, ping-pong status where handover continues to be tried may occur.

Generally, the communication modules may be operated at neighboring frequencies as follows in view of frequency, whereby mutual interference of the communication modules may be reduced.

The LTE module may be operated at TDD Band 40 (2300 MHz to 2400 MHz), and the WiFi module or the Bluetooth module may be operated at 2400 MHz to 2483.5 MHz which correspond to an unlicensed band. In this case, transmission of the LTE module may cause interference against the WiFi module or the Bluetooth module, and transmission of the WiFi module or the Bluetooth module may cause interference against reception of the LTE module.

Also, the LTE module may perform uplink transmission at FDD Band 7 (2500 MHz to 2700 MHz), and the Bluetooth module may be operated at 2400 MHz to 2483.5 MHz which correspond to an unlicensed band. In this case, uplink transmission of the LTE module may cause interference against reception of the WiFi module or the Bluetooth module.

Also, the LTE module may be operated at FDD Band 13 (UL: 777-787 MHz, DL: 746-756 MHz) or FDD Band 14 (UL: 788-798 MHz, DL: 758-768 MHz), and the GPS module may receive location information at 1575.42 MHz. In this case, uplink transmission of the LTE module may cause interference against reception of location information of the GPS module.

As one of solutions of the above problems, IDC interference between two transceivers may be prevented from occurring by allowing a frequency interval between respective transceiving signals or physical filters to be obtained sufficiently. However, if several wireless communication modules are operated at neighboring frequencies, it is difficult for the current filter technology to sufficiently eliminate interference.

Separately from an application method of a physical filter scheme, an IDC interference avoidance scheme may be considered about three cases as follows depending on whether there is any coordination with another communication module which coexists with the LTE module and there is any coordination between the LTE module and the base station to eliminate IDC interference.

The first case is that there is no coordination between the communication modules coexisting within one user equipment and between the LTE module and the base station to avoid IDC interference. In this case, the LTE module does not know information on the other communication module that coexists with the LTE module.

The second case is that there is coordination between communication modules coexisting in the user equipment. In this case, the LTE module may know action state (that is, ON/OFF state) between the coexisting modules, traffic transmission state, etc.

Finally, the third case is that there exists coordination between the user equipment as well as coordination between the modules coexisting in the user equipment. The LTE module may measure IDC interference through inter/intra frequency measurement as well as coordination with another module.

In the current 3GPP system, to solve the problem of IDC interference, 1) a method (frequency division multiplexing (FDM) method) for allowing a communication module, which causes interference, or a communication module affected by interference to change frequency, 2) a method (time division multiplexing (TDM) method) for allowing coexisting communication modules to use one frequency through time division are considered, and 3) a method (LTE power control (LTE PC) method) for allowing an LTE module to reduce interference, which affects another coexisting module, by controlling transmission power are considered. Detailed methods and procedures are currently under discussion in the 3GPP.

As described above, since IDC interference occurs in one user equipment, if the user equipment does not notify the base station of occurrence of IDC interference, the base station does not know occurrence of IDC interference. Accordingly, the user equipment needs to notify the base station of its IDC interference information, whereby the base station may perform handover for moving a frequency used for solving the IDC interference problem to another frequency and scheduling for using time resources through division. In other words, if IDC interference occurs, the user equipment needs to notify the base station of information required for performing FDM/TDM in the base station.

For example, IDC interference information required to perform FDM may include unusable frequency information affected by interference, etc. and information associated with direction of interference. The information associated with direction of interference may be configured differently in accordance with a case where the LTE module is affected by IDC interference, a case where another communication module in addition to the LTE module is affected by IDC interference, or a case where all the communication modules belonging to the user equipment are affected by IDC interference, depending on which module is affected by interference.

Also, IDC interference information required to perform TDM may include a DRX pattern desired by the user equipment or a bitmap pattern.

Moreover, the IDC interference information may include one bit indicating that a specific frequency or cell is affected by interference. The IDC interference information may be transmitted due to a trigger of a specific result (or measurement) report event, and may be reported together with the measured result or separately.

The user equipment should measure quality of a downlink frequency until the user equipment transfers the IDC interference information to the base station. However, the measured result may be affected by IDC interference in accordance with the implemented method of the user equipment. Accordingly, if the base station performs handover of the user equipment on the basis of the measured result affected by IDC interference, a problem may occur in that quality of service (QoS) of the user equipment may be deteriorated in a cell, to which the user equipment moves after handover, due to IDC interference. For this reason, a problem may occur in that the base station should perform handover for the corresponding user equipment to another cell.

Also, the LTE module may fail to exactly measure IDC interference in accordance with a transmission pattern of another communication module that coexists in the user equipment. In this case, a problem may occur in that QoS of the user equipment may be deteriorated as the base station performs handover for the user equipment having IDC interference to a frequency having IDC interference on the basis of inexact information.

Accordingly, the present invention suggests the first embodiment and the second embodiment according to transmission of IDC interference information collected until the corresponding timing to the base station when a specific measured result report event is triggered on the basis of measurement information configured by the base station in the method for allowing the LTE module of RRC_Connected state in the user equipment to transmit IDC interference information to the base station.

### First Embodiment

In the first embodiment of the present invention, it is assumed that indication information for reporting IDC interference information is included in measurement configuration information if a specific event is triggered when the base station configures measurement for the user equipment. For example, the base station may configure indication for reporting IDC Interference information to the base station with respect to a specific one among events A1, A2, A3, A4, A5, A6, B1, and B2 related to measurement event reporting and events of which timer expiration or trigger type is periodical.

Accordingly, the specific event configured by the base station may be the event that may be used by the base station for handover. For example, if the event A3 related to measurement occurs, indication for reporting collected IDC interference information may be included in the A3 event measurement configuration information.

Also, the indication may be included in a configuration message for measurement reporting, for example, a report configuration (reportConfig) message in case of the LTE.

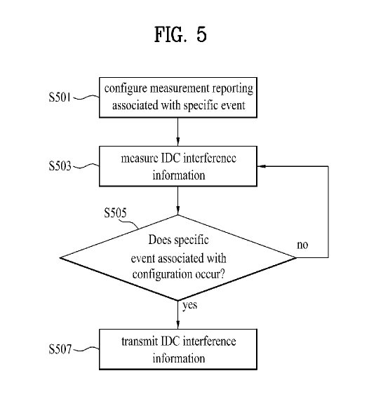

FIG. 5 is a flow chart illustrating a method for allowing a user equipment to transmit IDC interference information in accordance with the first embodiment of the present invention.

If a specific event occurs, the user equipment receives a message, in which indication for performing measurement reporting including IDC interference information is configured, from the base station. For example, IDC bit may be allocated to the specific event, whereby indication for measurement reporting including IDC interference information of the user equipment may be configured. The user equipment configures measurement reporting associated with the specific event in accordance with the received message (S501).

The user equipment measures an IDC interference level between a plurality of communication module coexisting therein (S503). According to the present invention, the user equipment may be configured to start IDC interference measurement by transmitting a message indicating operation start between the communication modules coexisting therein. For example, operation start of the communication modules may be a power-on operation of the communication modules or a traffic transmission and reception operation of the communication modules, and the communication modules coexisting in the user equipment may include at least one of a transceiving module for a WiFi system, a Bluetooth transceiving module, and a global positioning system (GPS) receiving module.

The user equipment checks whether the specific event has occurred in accordance with configuration of measurement reporting, and waits for new IDC interference measurement without performing measurement reporting including IDC interference information if the specific event does not occur (S505).

If the specific event occurs, the user equipment transmits a measurement report message, which includes IDC interference information, to the base station (S507). The IDC interference information may be provided to include an identifier indicating that a specific cell is affected by IDC interference, and may additionally include information for performing TDM/FDM. In other words, the user equipment may transmit a (measurement reporting) message, which includes IDC interference information comprised of at least one of frequency information affected by IDC interference and a DRX pattern or bitmap pattern for performing TDM. Also, if a plurality of frequency bands are used, even though an event occurs in association with one of the plurality of frequency bands, IDC interference information on the other frequencies may be included in the message and then transmitted.

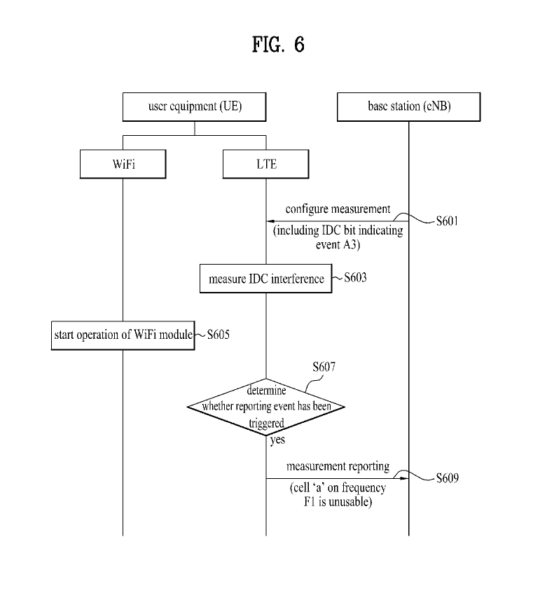

FIG. 6 is a reference diagram illustrating an operation of a user equipment according to the first embodiment of the present invention. In FIG. 6, it is assumed that the LTE communication module and the WiFi communication module coexist in the user equipment, and the LTE module may identify the frequency through which IDC interference occurs, through internal coordination between the communication modules, as well as actual measurement for IDC interference.

On the assumption that the LTE module reports a measured result of a cell ‘a’ as the cell ‘a’ fulfills A3 event condition, the first embodiment of the present invention will be described with reference to FIG. 6.

The base station measures frequencies F1, F2 and F3, and transmits a message indicating reporting of measurement information, which includes IDC interference information reporting, to the LTE module if the event A3 occurs. The user equipment performs configuration for IDC interference measurement on the basis of the message from the base station. Preferably, the base station may configure IDC bit, which indicates reporting of collected IDC interference information, in the indication message when the event A3 occurs (S601).

The LTE module of the user equipment performs measurement on the basis of the information configured at the step S601 (S603). At this time, it is assumed that frequencies F1, F2 and F3 are affected by IDC interference due to WiFi transmission as the WiFi module coexisting in the user equipment starts its operation (S605).

The LTE module of the user equipment determines whether a report event associated with IDC interference information has been triggered (S607). In other words, according to this embodiment, the LTE module checks whether the event A3 has occurred for the cell ‘a’.

If the report event, that is, the event 3 occurs for the cell ‘a’, the LTE module configures a message, which includes IDC interference information, to report the measured result. At this time, supposing that the cell ‘a’ is located on the frequency F1, since the cell ‘a’ located on the frequency F1 to be reported as the measured result is affected by IDC interference, the LTE module may configure a message to include an identifier indicating that the cell ‘a’ is affected by IDC interference, in addition to the existing measured result. Accordingly, measurement may be reported to the base station together with IDC interference information indicating that the cell ‘a’ on the frequency F1 is unusable (S609).

Also, in configuring the message, frequency information affected by IDC interference may be included in the message, or TDM information such as a DRX pattern and a bitmap pattern may be included in the message.

Moreover, supposing that the event A3 has occurred on the frequency F1, if IDC interference occurs at the other frequencies (that is, F2 and F3) in addition to the frequency F1, the LTE module may include IDC interference information at the frequencies F2 and F3 in the message even though the event for reporting of the measured result has not occurred at the frequencies F2 and F3.

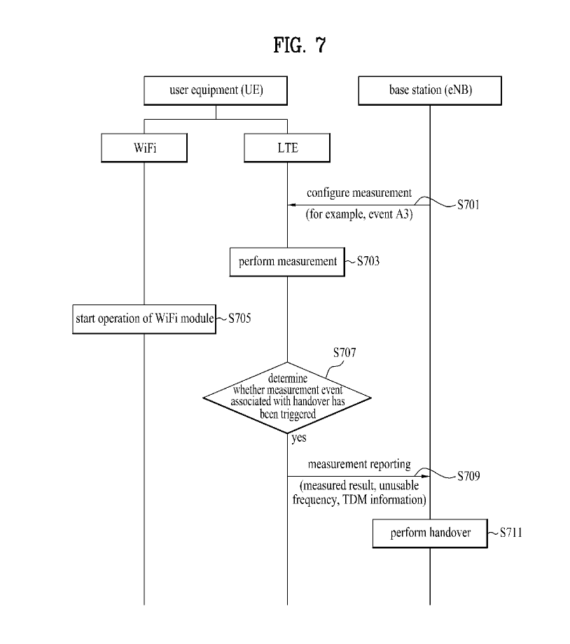

FIG. 7 is a reference diagram illustrating that an event related to handover is measured on the basis of the first embodiment of the present invention. The same description as the aforementioned description will be omitted.

If the base station transmits a message indicating measurement reporting including IDC interference information for the event (for example, A3) related to handover, the user equipment performs measurement on the basis of the received message. If the WiFi module coexisting in the user equipment starts its operation, it may be indicated for the LTE module.

The LTE module in the user equipment checks whether a measurement event associated with handover has been triggered. As a result, if the measurement event associated with handover has been triggered, the LTE module reports measurement to the base station with respect to IDC interference information of at least one of the measured result (related to IDC interference), unusable frequency and TDM information.

The base station (eNB) performs handover (FDM) on the basis of measurement reporting including IDC interference information received from the user equipment.

### Second Embodiment

In the second embodiment of the present invention, it is assumed that the user equipment reports IDC interference information, which is collected until an event related to handover occurs, to the base station if the event related to handover occurs. The event related to handover includes events A3, A4, A5, A6, B1 and B2, for example.

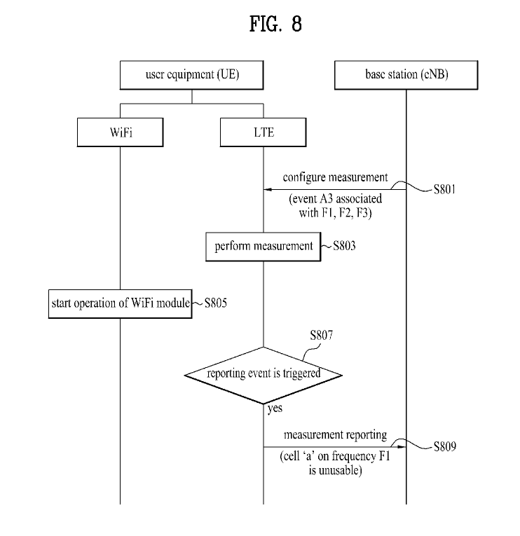

FIG. 8 is a reference diagram illustrating a method for allowing a user equipment to transmit IDC interference information in accordance with the second embodiment of the present invention. The same description as the aforementioned description will be omitted.

Referring to FIG. 8, the base station measures frequencies F1, F2 and F3 and transmits configuration information indicating reporting of measurement information to the LTE module of the user equipment if the event A3 occurs.

The LTE module of the user equipment performs measurement on the basis of the configured information. It is assumed that IDC interference has occurred for frequencies F1, F2 and F3 as the WiFi module starts an operation for data transmission and reception.

The LTE module checks whether the event A3 has occurred.

If the event A3 occurs, the LTE module configures a message for reporting of the measured result and transmits the configured message to the base station. When the user equipment configures the message of the measured result, if the LTE module determines that the event A3 is related to handover, the user equipment configures the message including collected IDC interference information. For example, since the cell ‘a’ located on the frequency F1 to be reported as the measured result is affected by IDC interference, the LTE module may transmits, to the base station, a message configured to include an identifier indicating that the cell ‘a’ is affected by IDC interference, in addition to the existing measured result.

Also, the LTE module may include frequency information affected by IDC interference in the message, or may include TDM information associated with a DRX pattern and a bitmap pattern, which are requested by the user equipment, in the message.

Alternatively, even though the event A3 has additionally occurred on the frequency F1, if IDC interference has occurred at the other frequencies (that is, F2 and F3) in addition to the frequency F1, the LTE module may include interference information at the frequencies F2 and F3 in the message even though the event for reporting of the measured result has not occurred at the frequencies F2 and F3.

Accordingly, in the present invention, when the user equipment having IDC interference performs measurement on the basis of measurement information configured by the base station and a specific measured result reporting related to handover is triggered, the user equipment transmits frequency information affected by IDC interference and TDM information to the base station. As a result, for QoS of the user equipment, the base station may exactly determine a corresponding frequency of a cell for handover of the user equipment.

Also, if a frequency for handover of the user equipment has IDC interference, the base station may quickly determine how to use the LTE module and another communication module through time division.

As a result, QoS of the user equipment may be prevented from being deteriorated by reducing the time when the user equipment is affected by IDC interference.

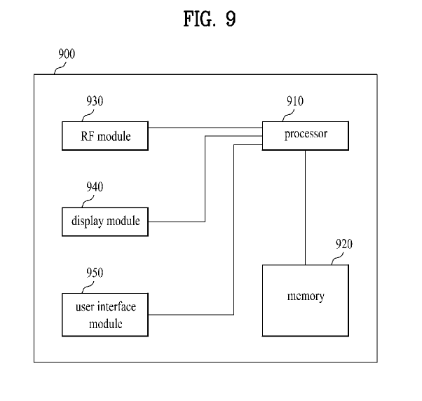

FIG. 9 is a block diagram illustrating a transceiver according to the embodiment of the present invention. The transceiver may be a part of the base station or the user equipment.

Referring to FIG. 9, the transceiver 900 includes a processor 910, a memory 920, a radio frequency (RF) module 930, a display module 940, and a user interface module 950.

The transceiver 900 is illustrated for convenience of description, and some of its modules may be omitted. Also, the transceiver 900 may further include necessary modules. Moreover, some modules of the transceiver 900 may be divided into segmented modules. The processor 910 is configured to perform the operation according to the embodiment of the present invention illustrated with reference to the drawings.

In more detail, if the transceiver 900 is a part of the base station, the processor 910 may serve to generate a control signal and map the generated control signal into a control channel configured within a plurality of frequency blocks. Also, if the transceiver 900 is a part of the user equipment, the processor 910 may identify the control channel indicated by the signals received from the plurality of frequency blocks and extract the control signal from the control channel.

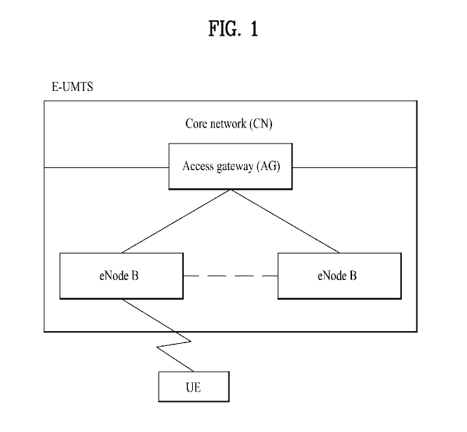

Afterwards, the processor 910 may perform a necessary operation on the basis of the control signal. The detailed operation of the processor 910 will be understood with reference to the disclosure described with reference to FIG. 1 to FIG. 7.

The memory 920 is connected with the processor 910 and stores an operating system, an application, a program code, and data therein. The RF module 930 is connected with the processor 910 and converts a baseband signal to a radio signal or vice versa. To this end, the RF module 930 performs analog conversion, amplification, filtering and frequency uplink conversion, or their reverse processes. The display module 940 is connected with the processor 910 and displays various kinds of information. Examples of the display module 940 include, but not limited to, a liquid crystal display (LCD), a light emitting diode (LED), and an organic light emitting diode (OLED). The user interface module 950 is connected with the processor 910, and may be configured by combination of well known user interfaces such as keypad and touch screen.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention have been described based on the data transmission and reception between a relay node and the base station. A specific operation which has been described as being performed by the base station may be performed by an upper node of the base station as the case may be. In other words, it will be apparent that various operations performed for communication with the user equipment in the network which includes a plurality of network nodes along with the base station can be performed by the base station or network nodes other than the base station. The base station may be replaced with terms such as a fixed station, Node B, eNode B (eNB), and access point. Also, the user equipment may be replaced with terms such as a mobile station (MS) and a mobile subscriber station (MSS).

The embodiments according to the present invention may be implemented by various means, for example, hardware, firmware, software, or their combination. If the embodiment according to the present invention is implemented by hardware, the embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the embodiment of the present invention may be implemented by a type of a module, a procedure, or a function, which performs functions or operations described as above. A software code may be stored in a memory unit and then may be driven by a processor. The memory unit may be located inside or outside the processor to transmit and receive data to and from the processor through various means which are well known.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

Although the method for transmitting IDC interference information in a wireless communication system and the apparatus for the same have been described based on the 3GPP LTE system, they may be applied to various wireless communication systems in addition to the 3GPP LTE system.

1. A method for transmitting In-Device Coexistence (IDC) interference information by a first communication module of a user equipment to a base station in a wireless communication system, the method comprising the steps of:
receiving a first message indicating measurement configuration associated with a specific event from the base station;
receiving a second message indicating operation start of at least one second communication module coexisting in the user equipment from the at least one second communication module;
measuring frequencies on the basis of operation frequency information of the first and second communication modules; and
transmitting the frequency measured results to the base station when the specific event occurs.

2. The method according to claim 1, wherein the specific event is associated with handover of the user equipment.

3. The method according to claim 1, wherein the measured result of frequencies includes IDC interference information.

4. The method according to claim 3, wherein the measured result of frequencies further includes frequency information affected by IDC interference.

5. The method according to claim 3, wherein the measured result of frequencies further includes time division multiplexing (TDM) information.

6. The method according to claim 3, wherein the measured result of frequencies further includes an identifier on a specific frequency band if the specific event is configured for the specific frequency band.

7. The method according to claim 6, wherein the measured result of frequencies further includes IDC interference information on a frequency band except for the specific frequency among frequency bands configured by the base station.

8. The method according to claim 1, wherein operation start of the second communication module is a power-on operation of the second communication module or a traffic transmission and reception operation of the second communication module.

9. The method according to claim 1, wherein the at least one second communication module includes at least one of a transceiving module for a WiFi system, a Bluetooth transceiving module, and a global positioning system (GPS) receiving module.

10. The method according to claim 1, wherein the first message is a configuration (reportConfig) message for measurement reporting, and is configured to further include a bit indicating IDC interference information reporting.

11. A user equipment in a wireless communication system, the user equipment comprising:
a first communication module for transmitting and receiving a signal to and from a first communication system; and
at least one second communication module for transmitting and receiving a signal to and from another communication system,
wherein the first communication module is configured to receive a first message indicating measurement configuration associated with a specific event from the base station, to receive a second message indicating operation start of the at least one second communication module coexisting in the user equipment from the at least one second communication module, to measure frequencies on the basis of operation frequency information of the first and second communication modules, and to transmit the frequency measured results to the base station when the specific event occurs.

12. The user equipment according to claim 11, wherein the specific event is associated with handover of the user equipment.

13. The user equipment according to claim 12, wherein the measured result of frequencies includes IDC interference information.
